(19) United States
(12) Patent Application Publication
(10) Pub. No.: US 2007/0152591 A1
(43) Pub. Date: Jul. 5, 2007

(54) Plasma display panel

(76) Inventor: Young-Gil Yoo, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/642,480

(22) Filed: Dec. 20, 2006

(30) Foreign Application Priority Data
Dec. 30, 2005 (KR) 10-2005-0135865

(51) Int. Cl. H01K 1/00; H01J 17/49

(52) U.S. Cl. 313/586; 313/582; 313/587; 313/580

(57) ABSTRACT

Provided is a plasma display panel that displays images using visible light emitted from phosphor layers formed in discharge cells as a result of discharges in the discharge cells. The plasma display panel includes a first substrate and a second substrate facing each other, a plurality of barrier ribs disposed to define a space into a plurality of discharge cells between the first and second substrates, sustain electrode pairs extending in a direction on the first substrate crossing the discharge cells, address electrodes crossing the sustain electrode pairs, a first dielectric layer covering the sustain electrode pairs, a second dielectric layer covering the address electrodes, phosphor layers formed in the discharge cells, and an adsorption layer formed in the discharge cells to adsorb impurity gasses and moisture in the discharge cells.

### CROSS-REFERENCE TO RELATED APPLICATIONS

This application claims the benefit of Korean Patent Application No. 10-2005-0135865, filed on Dec. 30, 2005, in the Korean Intellectual Property Office, the disclosure of which is incorporated herein in its entirety by reference.

### BACKGROUND OF THE INVENTION

1. Field of the Invention

The present embodiments relate to a plasma display panel, and more particularly, to a plasma display panel that displays an image made by combining visible light, which is emitted from a phosphor material of a phosphor layer formed in a discharge cell due to discharges in the discharge cell.

2. Description of the Related Art

Plasma display panels, which are expected to replace conventional cathode ray tube display devices, have received much attention. Plasma display panels display images using visible light emitted through a process in which a phosphor material formed in a predetermined pattern in a space is excited with ultraviolet rays generated by discharges of a discharge gas in the space when a discharge voltage is applied to the electrodes.

FIG. 1 is an exploded perspective view of a conventional plasma display panel (PDP).

Referring to FIG. 1, a typical AC PDP 10 includes an upper plate 50 on which images are displayed and a lower plate 60 coupled to the upper plate 50 and parallel to the upper plate 50. Sustain electrode pairs 12 in which an X electrode 31 and a Y electrode 32 form a pair are formed on a front substrate 11 of the upper plate 50. Address electrodes 22 crossing the X and Y electrodes 31 and 32 of the front substrate 11 are disposed on a rear substrate 21 of the lower plate 60 that faces a surface of the front substrate 11 where the sustain electrode pairs 12 are disposed.

First and second dielectric layers 15 and 25 in which the electrodes are buried are respectively formed on the front substrate 11 where the sustain electrode pairs 12 are formed and on the rear substrate 21 where the address electrodes 22 are formed. A protective layer 16 is usually formed of MgO on a rear surface of the first dielectric layer 15, and barrier ribs 30 that maintain a discharge distance between the front substrate 11 and the rear substrate 21 and prevent electrical and optical crosstalk between discharge cells are formed on an entire surface of the second dielectric layer 25.

The X electrode 31 and the Y electrode 32 include transparent electrodes 31a and 32a, respectively, and bus electrodes 31b and 32b, respectively. A space formed by the pair of the X electrode 31 and the Y electrode 32 and the address electrodes 22 crossing the X and Y electrodes 31 and 32 is a unit discharge cell 70, which forms one discharge unit. The transparent electrodes 31a and 32a are formed of a conductive transparent material that can generate discharges and does not interrupt the progress of light emitted from phosphor layers 26 toward the front substrate 11. The transparent material can be indium tin oxide (ITO).

Red, green, and blue phosphor layers 26 are coated on both side surfaces of the barrier ribs 30 and on an entire surface of the second dielectric layer 25 where the barrier ribs 30 are not formed. The phosphor layers 26 are coated on the barrier ribs 30 and the second dielectric layer 25 by printing phosphor pastes on the barrier ribs 30 and the second dielectric layer 25 and then drying and baking the phosphor pastes.

During the process of forming the phosphor layers, organic materials in the phosphor pastes vaporize or remain in the phosphor layers 26 as residual carbon. However, residual carbon that has not completely burnt or other organic materials cause outgassing. A discharge gas in discharge cells is contaminated by these gases, thereby reducing the lifetime and characteristics of the phosphor material.

A binder is used to coat the phosphor materials. However, moisture can be produced in the discharge cells by the combustion of elements included in the binder. The moisture in the discharge cell can cause degradation of the phosphor material. Therefore, a plasma display panel that avoids these problems is needed.

### SUMMARY OF THE INVENTION

The present embodiments provide a plasma display panel that prevents the contamination of a discharge space and increases discharge efficiency by coating a material on barrier ribs to adsorb contamination materials such as residual carbon or moisture generated from phosphor layers.

According to an aspect of the present embodiments, there is provided a plasma display panel comprising a first substrate and a second substrate facing each other, a plurality of barrier ribs disposed to define a space into a plurality of discharge cells between the first and second substrates, sustain electrode pairs extending in a direction on the first substrate crossing the discharge cells, address electrodes crossing the sustain electrode pairs, a first dielectric layer covering the sustain electrode pairs, a second dielectric layer covering the address electrodes, phosphor layers formed in the discharge cells, and an adsorption layer formed in the discharge cells to adsorb impurity gasses and moisture in the discharge cells.

The adsorption layer may be coated on the barrier ribs.

The adsorption layer may be coated on the barrier ribs and the second dielectric layer in the discharge cells.

The adsorption layer may be coated under the phosphor layers.

The adsorption layer may be formed by coating an ion exchanged zeolite in the discharge cells.

The adsorption layer may be formed by coating at least one of a lithium ion exchanged mordenite, a sodium ion exchanged mordenite, and a calcium ion exchanged FAU (faujasite) in the discharge cells.

According to another aspect of the present embodiments, there is provided a plasma display panel comprising: a first substrate and a second substrate facing each other; a plurality of barrier ribs disposed to define a space into a plurality of discharge cells between the first and second substrates; and an adsorption layer formed in the discharge cells to adsorb impurity gases and moisture in the discharge cells.

The adsorption layer may be coated on the barrier ribs.

A second dielectric layer may be formed of a dielectric on the second substrate, and the adsorption layer may be coated on the barrier ribs and the second dielectric layer in the discharge cells.

Phosphor layers may be formed on inner surfaces of the barrier ribs and the second dielectric layer, and the adsorption layer may be formed under the phosphor layers.

According to the present embodiments, contamination of a discharge space can be prevented and discharge efficiency of the PDP can be increased by coating a material on barrier ribs to adsorb contamination materials such as residual carbon or moisture generated from phosphor layers.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a conventional plasma display panel (PDP);

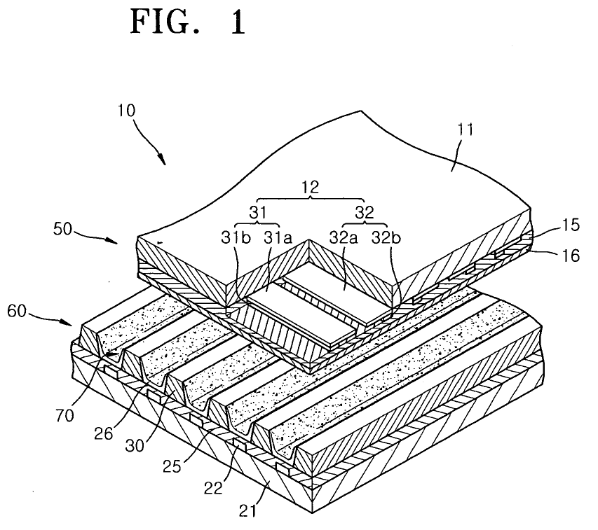

FIG. 2 is a partial cutaway exploded perspective view illustrating a plasma display panel according to an embodiment; and

FIG. 3 is a cross-sectional view taken along line III-III of FIG. 2.

### DETAILED DESCRIPTION OF THE PREFERRED EMBODIMENT

The present embodiments will now be described more fully with reference to the accompanying drawings in which exemplary embodiments are shown.

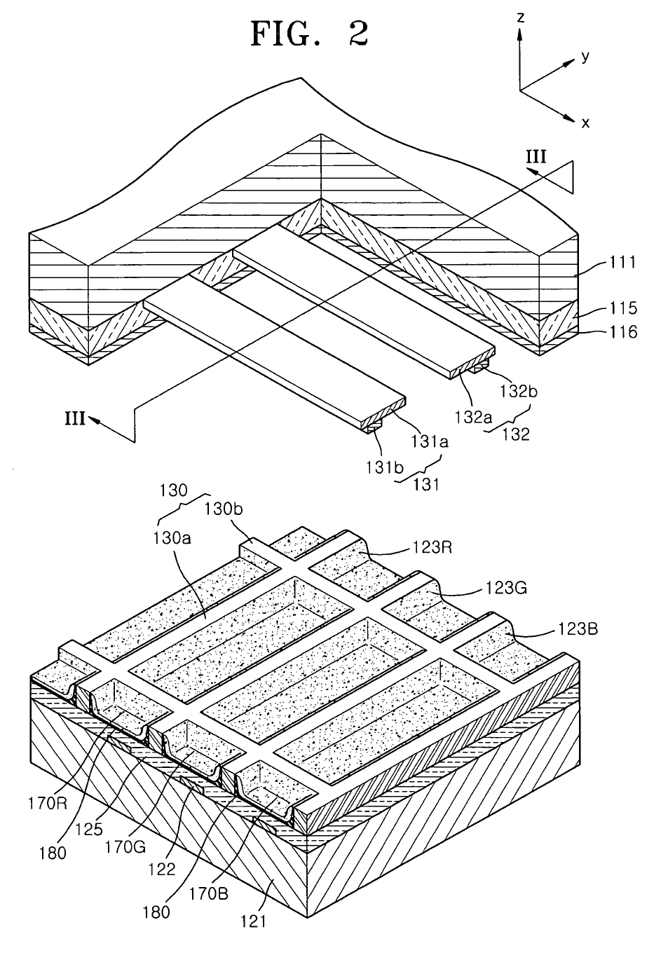

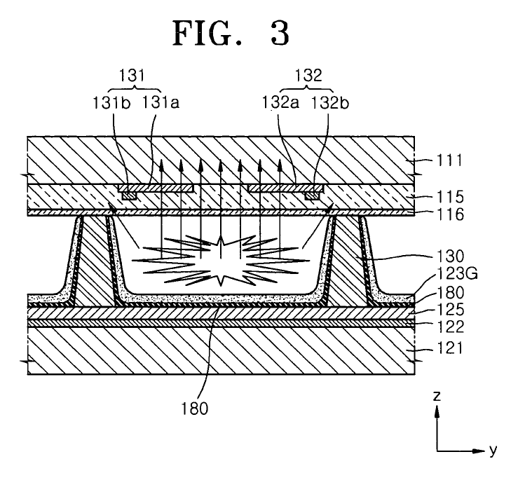

FIG. 2 is a partial cutaway exploded perspective view illustrating a plasma display panel (PDP) according to an embodiment, and FIG. 3 is a cross-sectional view taken along line III-III of FIG. 2.

Referring to FIGS. 2 and 3, an AC PDP is depicted in FIG. 2. The PDP includes a first substrate 111, a second substrate 121, sustain electrode pairs 131 and 132, address electrodes 122, a plurality of barrier ribs 130, a protective layer 116, phosphor layers 123R, 123G, and 123B, a first dielectric layer 115, a second dielectric layer 125, a discharge gas (not shown), and an adsorption layer 180.

The first substrate 111 can be a front substrate, and the second substrate 121 can be a rear substrate. The first dielectric layer 115 can be a front dielectric layer, and the second dielectric layer 125 can be a rear dielectric layer.

The front substrate 111 and the rear substrate 121 are disposed a predetermined distance apart, and define a discharge space where discharges are generated. The front substrate 111 and the rear substrate 121 may be formed of a material having a high visible light transmittance such as, for example, glass. However, to increase the bright room contrast, the front substrate 111 and/or the rear substrate 121 may be colored.

The barrier ribs 130 are disposed between the front substrate 111 and the rear substrate 121. The barrier ribs 130 can be disposed on the rear dielectric layer 125 depending on the manufacturing process. The barrier ribs 130 define a discharge space by dividing the discharge space into a plurality of discharge cells 170R, 170G, and 170B, and prevent optical and electrical crosstalk between the discharge cells 170R, 170G, and 170B. In FIG. 2, the discharge cells 170R, 170G, and 170B are defined by the barrier ribs 130, which consist of horizontal barrier ribs 130b and vertical barrier ribs 130a, and have a matrix arrangement and a rectangular shape horizontal cross-section, but the present embodiments are not limited thereto. That is, the barrier ribs 130 may define the discharge space by dividing the discharge space into discharge cells 170R, 170G, and 170B having a polygon shape horizontal cross section such as a triangle or a pentagon, a circle or an oval shape horizontal cross-section, or an open type cross section such as a stripe. Also, the discharge cells 170R, 170G, and 170B can be defined by the barrier ribs 130 in a waffle or delta shape, for example.

The sustain electrode pairs 131 and 132 are disposed on the front substrate 111 facing the rear substrate 121. Each of the sustain electrode pairs 131 and 132 is a pair of sustain electrodes 131 and 132 formed on a rear surface of the front substrate 111 to cause a sustain discharge, and the sustain electrode pairs 131 and 132 are arranged parallel to each other on the front substrate 111 and separated by a predetermined distance.

Of the pair of sustain electrodes 131 and 132, one sustain electrode is an X electrode 131 that serves as a common electrode, and the other sustain electrode of the pair of sustain electrodes 131 and 132 is a Y electrode 132 that serves as a scan electrode. In the present embodiment, the sustain electrode pairs 131 and 132 are formed on the front substrate 111, but the location of the sustain electrode pairs 131 and 132 is not limited thereto. For example, the sustain electrode pairs 131 and 132 can be disposed a predetermined distance apart from the front substrate 111 in a direction toward the rear substrate 121.

The X electrode 131 and the Y electrode 132 include transparent electrodes 131a and 132a, respectively, and bus electrodes 131b and 132b, respectively. The transparent electrodes 131a and 132a are formed of a transparent and conductive material that can generate a discharge and does not interrupt the progress of light emitted from the phosphor layers 123R, 123G, and 123B through the front substrate 111. For example, the transparent electrodes 131a and 132a may be formed of indium tin oxide (ITO).

However, a transparent and conductive material such as ITO generally has a high resistance. Accordingly, if the sustain electrodes 131 and 132 are formed using only the transparent electrodes 131a and 132a, a voltage drop in a length direction is large, resulting in high driving power consumption and a slow response speed. To solve these drawbacks, the bus electrodes 131b and 132b, which are formed of metal with a narrow width, are disposed on the transparent electrodes 131a and 132a. The bus electrodes 131b and 132b can be formed in a single layer structure using a metal such as, for example, Ag, Al, or Cu, or can be formed in multiple layers using, for example, Cr/Al/Cr. The transparent electrodes 131a and 132a and the bus electrodes 131b and 132b can be formed using a photo etching method, a photolithography method, etc.

The shapes and locations of the X electrode 131 and the Y electrode 132 will now be described. The bus electrodes 131b and 132b are disposed parallel to each other and separated by a predetermined distance in the unit discharge cells 170R, 170G, and 170B, and extend across the discharge cells 170R, 170G, and 170B. As described above, the transparent electrodes 131a and 132a are respectively electrically connected to the bus electrodes 131b and 132b, and the rectangular shape transparent electrodes 131a and 132a can be separately disposed in each of the unit discharge cells 170R, 170G, and 170B. One edge of each of the transparent electrodes 131a and 132a is connected to the bus electrodes 131b and 132b, respectively, and the other edge of each of the transparent electrodes 131a and 132a can be disposed to face a central portion of each of the discharge cells 170R, 170G, and 170B.

The front dielectric layer 115 covering the sustain electrode pairs 131 and 132 is formed on the front substrate 111. The front dielectric layer 115 prevents crosstalk between adjacent X electrodes 131 and Y electrodes 132, and also, prevents the X electrodes 131 and the Y electrodes 132 from being damaged due to direct collisions of charged particles or electrons with the X electrodes 131 and the Y electrodes 132. Also, the front dielectric layer 115 can function to induce charges. The front dielectric layer 115 can be formed of, for example, PbO, B₂O₃, SiO₂, etc.

Also, the PDP may further include the protective layer 116 covering the front dielectric layer 115. The protective layer 116 also protects the front dielectric layer 115 from being damaged due to collisions of charged particles or electrons with the front dielectric layer 115 during discharging.

The protective layer 116 facilitates the occurrence of plasma discharge by emitting secondary electrons during discharges. The protective layer 116 is formed of a material having a high secondary electron emission coefficient and high visible light transmittance. The protective layer 116 can be formed in a thin film using, for example, a sputtering method or an electron beam evaporation method after the front dielectric layer 115 is formed.

The address electrodes 122 are disposed on the rear substrate 121 facing the front substrate 111. The address electrodes 122 extend across the X electrode 131 and the Y electrode 132, which cross the discharge cells 170R, 170G, and 170B.

The address electrodes 122 are formed to generate address discharges that facilitate the generation of sustain discharges between the X electrode 131 and the Y electrode 132. More specifically, the address electrodes 122 reduce the voltage needed to generate the sustain discharge. Address discharges are generated between the Y electrodes 132 and the address electrodes 122. When an address discharge is completed, wall charges are accumulated on the X electrodes 131 and the Y electrodes 132, which facilitate the generation of sustain discharges between the X electrodes 131 and the Y electrodes 132.

The spaces formed by the pairs of the X electrodes 131 and the Y electrodes 132 and the address electrodes 122 that cross the X and Y electrodes 131 and 132 are unit discharge cells 170R, 170G, and 170B.

The rear dielectric layer 125 covering the address electrodes 122 is formed on the rear substrate 121. The rear dielectric layer 125 is formed of a dielectric that can prevent the address electrodes 122 from being damaged due to collisions of charged particles or electrons with the address electrodes 122 during a discharge, and can induce charges. For example, the rear dielectric layer 125 may be formed of PbO, B₂O₃, SiO₂, and the like.

Red, green, and blue phosphor layers 123R, 123G, and 123B are disposed on both side surfaces of the barrier ribs 130 formed on the rear dielectric layer 125 and on an entire surface of the rear dielectric layer 125 where the barrier ribs 130 are not formed. The phosphor layers 123R, 123G, and 123B include a component that emits visible light when the component is excited by ultraviolet rays. The phosphor layer 123R formed in the red light emitting discharge cell includes a phosphor material such as Y(V,P)O₄:Eu, the phosphor layer 123G formed in the green light emitting discharge cell includes a phosphor material such as Zn₂SiO₄:Mn, YBO₃:Tb, etc., and the phosphor layer 123B formed in the blue light emitting discharge cell includes a phosphor material such as BAM:Eu.

A discharge gas comprising a mixture of, for example, Ne gas and Xe gas is filled into the discharge cells 170R, 170G, and 170B. When the filling of the discharge gas is finished, the front substrate 111 and the rear substrate 121 are coupled to each other using a sealing member such as frit glass formed on edges of the front and rear substrates 111 and 121.

After the discharge gas is excited during a sustain discharge, ultraviolet rays are emitted from the discharge gas as the energy level of the discharge gas is reduced. The ultraviolet rays excite the phosphor layers 123R, 123G, and 123B coated in the discharge cells 170R, 170G, and 170B, and visible light is emitted from the phosphor layers 123R, 123G, and 123B as the energy level of the phosphor layers 123R, 123G, and 123B is reduced. The visible light forms images on the PDP by transmitting through the front dielectric layer 115 and the front substrate 111.

The adsorption layer 180 can be formed in the discharge cell to adsorb impurity gases in the discharge cells 170R, 170G, and 170B. For this purpose, the adsorption layer 180 may be coated on the barrier ribs 130 in the discharge cells 170R, 170G, and 170B. Alternatively, the adsorption layer 180 can be coated under the phosphor layers 123R, 123G, and 123B on the barrier ribs 130 and the rear dielectric layer 125.

The adsorption layer 180 may be formed by coating an ion exchanged zeolite such as a lithium ion exchanged mordenite, or a sodium ion exchanged mordenite, or a calcium ion exchanged FAU (faujasite) resulting in a zeolite adsorption layer. Besides the above described ion exchanged zeolites, the adsorption layer 180 can be formed of various ion exchanged zeolites that can adsorb impurity gases in the discharge cells 170R, 170G, and 170B, and any material that can adsorb impurity gases can be used.

Ion exchanged zeolite has an aluminosilicate structure in which a basic tetrahedral structure of AlO₄ and SiO₄ connected by oxygen is connected in three dimensions. The basic structure is a sodalite unit, and if it is an A type zeolite, the basic structure is formed in a D4R structure, and if it is an X and a Y type zeolite, it is formed in a three dimensional shape D6R structure.

This structure includes voids connected to a channel filled with positive metal ions and water. Accordingly, the metal positive ions are highly mobile, and thus, can be substituted by any other metal positive ion at any time. Therefore, zeolite can be changed to a different structure through metal ion exchange or dehydration.

Zeolite is inexpensive and has a high thermal resistance. The zeolite has many molecular-sized pores, and has a large surface area. Therefore, a small amount of zeolite can adsorb a lot of impurity gases or gaseous impurities. An impurity gas can be selectively adsorbed or decomposed using an ion exchanged zeolite in which a positive metal ion of zeolite is exchanged.

Due to the above characteristics, zeolite can readily adsorb or decompose impurity gases and moisture in the discharge cells 170R, 170G, and 170B. The impurity gases in the discharge cells 170R, 170G, and 170B can be, for example, carbon monoxide, carbon dioxide, water, and hydrocarbons.

Carbon residue or water remaining in the phosphor layers 123R, 123G, and 123B after baking vaporizes after a period of operation due to temperature increase in the discharge cells 170R, 170G, and 170B or the excitation of the phosphor material by high energy, and can contaminate the discharge gas or an oxide film. However, according to the present embodiments, the adsorption layer 180 formed of a porous material such as zeolite is formed on the barrier ribs 130 and the rear dielectric layer 125, on which the phosphor layers 123R, 123G, and 123B are formed, and thus, the impurity gas or moisture can be adsorbed.

Accordingly, the contamination of inner spaces of the discharge cells by impurity gases or moisture can be prevented or reduced, and the resulting degradation of the phosphor material can be prevented. Also, reductions in brightness and luminous efficiency in the phosphor material can be prevented, and discharge efficiency and the lifetime of a PDP can be increased, thereby increasing the reliability of the PDP.

According to the present embodiments, residual carbon or moisture generated in phosphor layers can be adsorbed by forming a material that can adsorb contamination material or moisture on barrier ribs, thereby preventing the contamination of discharge cells and the degradation of phosphor materials.

Also, the reduction of brightness and efficiency of the phosphor materials can be prevented by preventing the degradation of the phosphor materials.

Also, the discharge efficiency can be increased by preventing the reduction of brightness and efficiency of the phosphor materials.

The lifetime of the phosphor materials and the PDP can be increased, thereby increasing the reliability of the PDP.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a first substrate and a second substrate facing each other;
a plurality of barrier ribs disposed to define a plurality of discharge cells between the first and second substrates;
sustain electrode pairs extending in a direction on the first substrate crossing the discharge cells;
address electrodes crossing the sustain electrode pairs;
a first dielectric layer covering the sustain electrode pairs;
a second dielectric layer covering the address electrodes;
phosphor layers formed in the discharge cells; and
an adsorption layer formed in the discharge cells to adsorb impurity gases and moisture in the discharge cells.

2. The plasma display panel of claim 1, wherein the adsorption layer is on the barrier ribs.

3. The plasma display panel of claim 1, wherein the adsorption layer is on the barrier ribs and the second dielectric layer in the discharge cells.

4. The plasma display panel of claim 1, wherein the adsorption layer is under the phosphor layers.

5. The plasma display panel of claim 1, wherein the adsorption layer is formed of an ion exchanged zeolite in the discharge cells.

6. The plasma display panel of claim 1, wherein the adsorption layer is formed of a lithium ion exchanged mordenite in the discharge cells.

7. The plasma display panel of claim 1, wherein the adsorption layer is formed of a sodium ion exchanged mordenite in the discharge cells.

8. The plasma display panel of claim 1, wherein the adsorption layer is formed of a calcium ion exchanged FAU (faujasite) in the discharge cells.

9. A plasma display panel comprising:
a first substrate and a second substrate facing each other;
a plurality of barrier ribs disposed to define a plurality of discharge cells between the first and second substrates; and
an adsorption layer formed in the discharge cells to adsorb impurity gases and moisture in the discharge cells.

10. The plasma display panel of claim 9, wherein the adsorption layer is on the barrier ribs.

11. The plasma display panel of claim 9, wherein a second dielectric layer is formed of a dielectric on the second substrate, and the adsorption layer is on the barrier ribs and the second dielectric layer in the discharge cells.

12. The plasma display panel of claim 11, wherein phosphor layers are formed on inner surfaces of the barrier ribs and the second dielectric layer, and the adsorption layer is formed under the phosphor layers.

13. The plasma display panel of claim 9, wherein the adsorption layer is formed of an ion exchanged zeolite on the discharge cells.

14. The plasma display panel of claim 9, wherein the adsorption layer is formed of a lithium ion exchanged mordenite.

15. The plasma display panel of claim 9, wherein the adsorption layer is formed of a sodium ion exchanged mordenite.

16. The plasma display panel of claim 9, wherein the adsorption layer is formed of a calcium ion exchanged FAU (faujasite).
